(19) United States
(12) Patent Application Publication
(10) Pub. No.: US 2004/0187530 A1
(43) Pub. Date: Sep. 30, 2004

(54) Systems and methods for containing and locking assets

(75) Inventors: Michael Lax, Syosset, NY (US); Agjah I. Libohova, Bayside, NY (US); Timothy J. Keuning, Northport, NY (US)

Correspondence Address: FISH & NEAVE, 1251 AVENUE OF THE AMERICAS, 50TH FLOOR, NEW YORK, NY, 10020-1105, US

(73) Assignee: Autronic Plastics, Inc.

(21) Appl. No.: 10/817,713

(22) Filed: Apr. 1, 2004

Related U.S. Application Data
(63) Continuation of application No. 10/775,259, filed on Feb. 9, 2004.
(60) Provisional application No. 60/456,996, filed on Mar. 21, 2003.
(60) Provisional application No. 60/458,028, filed on Mar. 26, 2003.
(60) Provisional application No. 60/460,830, filed on Apr. 4, 2003.
(60) Provisional application No. 60/505,496, filed on Sep. 24, 2003.
(60) Provisional application No. 60/530,529, filed on Dec. 17, 2003.

(51) Int. Cl. E05B 65/00

(52) U.S. Cl. 70/57.1

(57) ABSTRACT

Systems and methods for locking and unlocking an asset placed in a containing element may include a locking member. The containing element may be closable and may include a first lock receiving element and a second lock receiving element. The first lock receiving element may be drawn together with the second lock receiving element to close the containing element such that the first and second lock receiving elements are enclosed within the containing element when the containing element is closed. The containing element may be configured to receive an asset container. The containing element may be configured to detachedly contain at least one item. A locking member may include a base configured to be present within both the first and second lock receiving elements when the containing element is closed. The locking member may include a magnetically releasable catch mechanism configured to engage the containing element and remain stationary relative to the containing element when a first magnetic field is applied. The catch mechanism may be released using a second magnetic field that is greater than the first magnetic field.

### CROSS-REFERENCES TO RELATED APPLICATIONS

This application claims the benefit of U.S. Provisional Applications Nos. 60/456,996, filed Mar. 21, 2003; 60/458,028, filed Mar. 26, 2003; 60/460,830, filed Apr. 4, 2003; 60/505,496, filed Sep. 24, 2003; and 60/530,529, filed Dec. 17, 2003, all of which are hereby incorporated by reference herein in their entireties.

### BACKGROUND OF THE INVENTION

The present invention relates to systems and methods that may be used to secure assets. In particular, the invention relates to containers for securing assets in a storage, retail sales or rental environment.

Such containers may provide an individual with a physical asset or item at a point of distribution (which, as used herein, includes a point of sale or rental) and require the asset to be removed from the system before the item is used.

In order to make a shopping experience more enjoyable, items are often displayed for sale or rental in a manner in which they are they are easily available for touching and manipulation by a customer. Consumers may view the item which is inside the container to determine whether they are interested in buying or renting the item. The experience may be less enjoyable if access to the item is limited to viewing the item in a display case or on the Internet, before purchasing. The method of providing a consumer with an opportunity to inspect and manipulate the item before purchasing it is called “live sell.” Live sell may provide a consumer with an opportunity to view items or packaging materials in which the items are packaged. Packaging materials may include promotional information or decoration.

Live sell, however, is associated with a risk of theft. To prevent theft in a live sell environment, there is therefore a need to secure items while still allowing customers to enjoy the live sell experience. One method for securing an item involves enclosing the item and any packaging and decorations in a container that has an external lock. However, some external locks may be tampered with, because they are accessible to a thief.

It would be desirable, therefore, to provide a system for securing an item and any associate packaging and decorations in a manner that reduces the risk of tampering.

### BRIEF DESCRIPTIONS OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a perspective view of an apparatus in accordance with the principles of the invention;

FIG. 2 is a perspective view of the apparatus shown in FIG. 1 and an object present inside that apparatus in a state different from that shown in FIG. 1;

FIG. 2A is a cross-sectional view of the apparatus shown in FIG. 1 and an object present inside that apparatus taken along line 2A-2A, shown in FIG. 1;

FIG. 3 is a perspective view of an apparatus that may be included in the apparatus shown in FIG. 1;

FIG. 4 is a perspective view of an apparatus that may be included in the apparatus shown in FIG. 1;

FIG. 5 is a perspective view of another apparatus in accordance with the principles of the invention;

FIG. 6 is a perspective view of the apparatus shown in FIG. 5 in a state different from that shown in FIG. 5;

FIG. 7 is a perspective view of an apparatus in accordance with the principles of the invention;

FIG. 8 is a perspective view of a portion of yet another apparatus in accordance with the principles of the invention;

FIG. 9 is a perspective view of yet another apparatus in accordance with the principles of the invention;

FIG. 10 is another perspective view of the apparatus shown in FIG. 9;

FIG. 11 is a perspective view of still another apparatus in accordance with the principles of the invention;

FIG. 12 is a perspective view of a portion of yet another apparatus in accordance with the principles of the invention;

FIG. 13 is a perspective view of a portion of yet another apparatus in accordance with the principles of the invention;

FIG. 14 is a perspective view of the portion shown in FIG. 13 in a state different from that shown in FIG. 13;

FIG. 15 is a perspective view of yet another apparatus in accordance with the principles of the invention;

FIG. 16 is a perspective view of a portion of yet another apparatus in accordance with the principles of the invention;

FIG. 17 is another perspective view of the apparatus shown in FIG. 15;

FIG. 18 is a perspective view of yet another apparatus in accordance with the principles of the invention;

FIG. 19 is a perspective view of yet another apparatus in accordance with the principles of the invention;

FIG. 20 is a perspective view of the apparatus shown in FIG. 19 in a state different from that shown in FIG. 19;

FIG. 21 is a perspective view of a portion of yet another apparatus in accordance with the principles of the invention;

FIG. 22 is a perspective view of yet another apparatus in accordance with the principles of the invention;

FIG. 23 is another perspective view of the apparatus shown in FIG. 22 showing the apparatus in combination with other apparatus in accordance with the principles of the invention;

FIG. 24 is another perspective view of the combination of apparatus shown in FIG. 23;

FIG. 25 is a perspective view of yet another apparatus in accordance with the principles of the invention;

FIG. 26 is another perspective view of the apparatus shown in FIG. 25;

FIG. 27a is a schematic diagram illustrating a principle of operation of an apparatus such as that shown in FIG. 11; and

FIG. 27b is another schematic diagram illustrating a principle of operation of an apparatus such as that shown in FIG. 11.

### DETAILED DESCRIPTION OF THE INVENTION

The invention may provide systems and methods for locking and unlocking a container. The container may be any type of container for containing an asset similar to containers described or shown in U.S. patent applications Ser. Nos. 09/858,457; 10/185,596 and 10/186,165 and U.S. Pat. No. 6,561,347, all of which are hereby incorporated by reference herein in their entireties. The invention may provide a lock for locking the containers. The asset may be any item suited for placing in a container. The item may be any consumer, medical, industrial, electrical, entertainment, food, or other type of item. For example, without limitation, the asset may be a wristwatch, a printer cartridge, a DVD, a CD, a memory chip, a set of razor blades, an electric circuit, a computer component, a recordable medium, a light bulb, an electronic circuit component or any other item. The asset may be an item that is normally packaged as a group, such as a paperclip, a thumbtack, or a pencil.

In some embodiments, the invention may include an asset locking system that includes a closable containing element. The containing element may include a first lock receiving element and a second lock receiving element. The first lock receiving element may be drawn together with the second lock receiving element to close the containing element such that the first and second lock receiving elements are enclosed within the containing element when the containing element is closed. The containing element may be configured to receive an asset container. The system may include a locking member. The locking member may include a base configured to be at least partially present within the first lock receiving element and at least partially present within the second lock receiving element when the containing element is closed.

In some embodiments, the locking member may include a catch mechanism that is attached to the base and configured to be moved relative to the base by a magnetic field.

In some embodiments, the first lock receiving element may include a first loop and the second lock receiving element may include a second loop. The first loop and the second loop may form a lock receiving channel configured to receive the locking member.

In some embodiments, the asset container may be a rhombohedron.

In some embodiments, the containing element may include a first enclosing member that supports the first lock receiving element and a second enclosing member that supports the second lock receiving element. The second enclosing member may be coupled to the first enclosing member.

In some embodiments, the asset locking container may include a first planar wall and a second planar wall. The first planar wall may be set apart from and parallel to the second planar wall.

In some embodiments, the first enclosing member may include a first surface and the second enclosing member may include a second surface. When the asset container is present in the containing element and the containing element is closed, the first surface may be held nearly flush to the first planar wall, and the second surface may be held nearly flush to the second planar wall.

In some embodiments, when the asset container is present in the containing element and the containing element is closed, the first surface may be held flush against the first planar wall, and the second surface may be held flush against the second planar wall.

In some embodiments, the first enclosing member may be coupled to the second enclosing member by a hinge. The hinge may include a pin that is not visible from a location outside the containing element when the containing element is closed. Such a pin may be referred to as a “hidden pin.”

In some embodiments, the hinge may include a flexible web of material. Such a hinge may be referred to as a “living hinge ” Access to an end of the living hinge may be at least partially prevented by the first and second enclosing members when the containing element is closed. The hinge may thus be “concealed.”

In some embodiments of the invention, the locking member may include a proximal end and a distal end. The distal end may be configured to be inserted into the containing element before the proximal end is inserted into the containing element.

The locking member may include a security tag support structure. The support structure may be adjacent the distal end of the base. The support structure may be adjacent the proximal end of the base. The support structure may be a recessed portion of the base. The support structure may be a channel. The support structure may be an enclosure.

In some embodiments of the invention, the system may include a security tag. The support structure may be configured to support the security tag. The security tag may be a non-deactivatable security tag. The security tag may include a coil. The security tag may include a bobbin. The security tag may be an acousto-magnetic tag. The security tag may be configured to emit a radio-frequency signal. The security tag may be an electronic article surveillance (“EAS”) tag. The security tag may be configured to transmit an Electronic Product Code (“EPC”).

In some embodiments of the invention, a containing element may include a compartment configured to detachedly contain at least one item. In some embodiments, the compartment may be configured to contain a plurality of loose items. In some embodiments, the compartment may be configured to contain at least five loose items.

In some embodiments, the containing element may include a passageway passing through the first enclosing member and through the second enclosing member. The passageway may be configured to receive and rest on a shaft to hang or otherwise support the containing element.

The first enclosing member may include a first wall. The second enclosing member may include a second wall. The first wall may overlap the second wall when the containing element is closed.

In some embodiments, the containing element may include a graphic sleeve that may be visible when the containing element is closed. In some embodiments, the containing element may comprise a graphic insert that may be visible when the containing element is closed. The insert may be located inside the containing element. The insert may be located on the outer surface of the containing element.

In some embodiments of the invention, the containing element may include a locking channel. The locking member may include a base, a security tag and a security tag support structure. The base may be configured to be inserted into the locking channel.

In some embodiments, the locking member may include a catch mechanism attached to the base. In some embodiments, the catch mechanism may be configured to be moved relative to the base by a magnetic field.

In some embodiments, the catch mechanism may be configured to engage a lock receiving element attached to a containing element enclosure member. The locking member may include a stabilizer configured to stabilize the catch mechanism if the catch mechanism is displaced relative to the base when the locking member is pulled away from the lock receiving element.

In some embodiments, the locking member may include a channel stop configured to block access to the catch mechanism when the locking member is in the locking channel and the catch mechanism is engaged with a lock receiving element attached to a containing element enclosure member.

The locking member may include an actuator configured to prevent the catch mechanism from being disengaged from a containing element when the catch mechanism is engaged with the lock receiving element. The actuator may be configured to be actuated by a magnetic field.

Magnetic fields for actuating catch mechanisms and actuators according to the principles of the invention may be provided by a magnetic decoupler.

In some embodiments, the locking member may include a handle member attached to the base. When the locking member is urged out of a containing element and the catch mechanism is engaged with a lock receiving element attached to a containing element enclosure member, the handle member may be configured to break away from the base before the catch mechanism breaks away from the base.

In some embodiments of the invention, a method for unlocking a containing element configured to receive a locking member may be provided. The method may include providing a magnetically reactive element inside the containing element, such that the magnetically reactive element is configured to remain stationary relative to the containing element when a first magnetic field is applied to the locking member, and releasing the catch mechanism using a magnetic key generating a second magnetic field that is greater than the first magnetic field. The method may include identifying a magnetic key that configured to emit the first magnetic field. In some embodiments, the releasing may include affixing the magnetic key to a fixture. The fixture may be an immovable fixture.

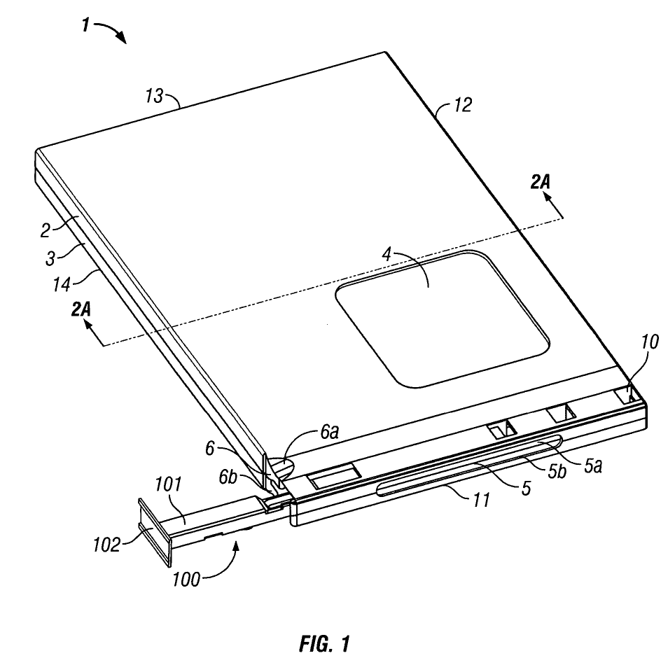

A number of features of illustrative embodiments of the invention are shown in FIGS. 1-24.

FIG. 1 shows an illustrative asset locking system according to the principles of the invention. The system will be described in the context of a retail sales environment, but it will be understood that the system may be used in any environment in which it is desirable to enclose or lock an asset. Lockable containing element 1 may be configured to contain one or more assets. Containing element 1 may contain a case in which the asset is placed. Containing element 1 may be opened at checkout in a retail sales facility. The case, along with any assets contained within the case, may be provided to a customer. Containing element 1 may remain in the facility. In some embodiments, containing element 1 may be re-used. Containing element 1 may include enclosing member 2 and enclosing member 3 that may be coupled together and configured to be brought adjacent each other to close containing element 1. Containing element 1 may include viewing window 4 to allow the customer to view the asset inside containing element 1 while shopping.

Containing element 1 may include finger slot 5 to facilitate opening containing element 1 to remove the asset or case. Finger slot 5 may include groove 5a on enclosing member 2 and corresponding groove 5b on enclosing member 3. Finger slot 5 may be located on side 11 of containing element 1 which is opposite side 13, where enclosing members 2 and 3 are coupled.

Containing element 1 may include locking channel 10 which may be configured to receive a lock such as locking member 100, which may be used to lock containing element 1 when containing element 1 is closed. Locking member 100 may include base 101, which may be elongated. Locking member 100 may include handle member 102, which may be configured to be grasped by a user to remove locking member 100 from channel 10.

Locking member 100 may be made of an acetyl homopolymer such as that sold under the trademark DELTIN SOOT, available from E.I. DuPont de Nemours of Delaware. Locking member 100 may be made from a material that is injection molded. Locking member 100 may be made from a material that provides flexibility and tensile strength that is sufficient to withstand tampering by a shoplifter when locking member 100 is engaged with containing element 1. Locking member 100 may be made of tough, moldable resin, that has both flexibility and tensile strength to resist tampering, or any other suitable material.

Containing element 1 may include cutout 6 to facilitate grasping handle member 102. Cutout 6 may include groove 6a on enclosing member 2 and corresponding groove 6b on enclosing member 3. Cutout 6 may be located on side 14 of containing element 1.

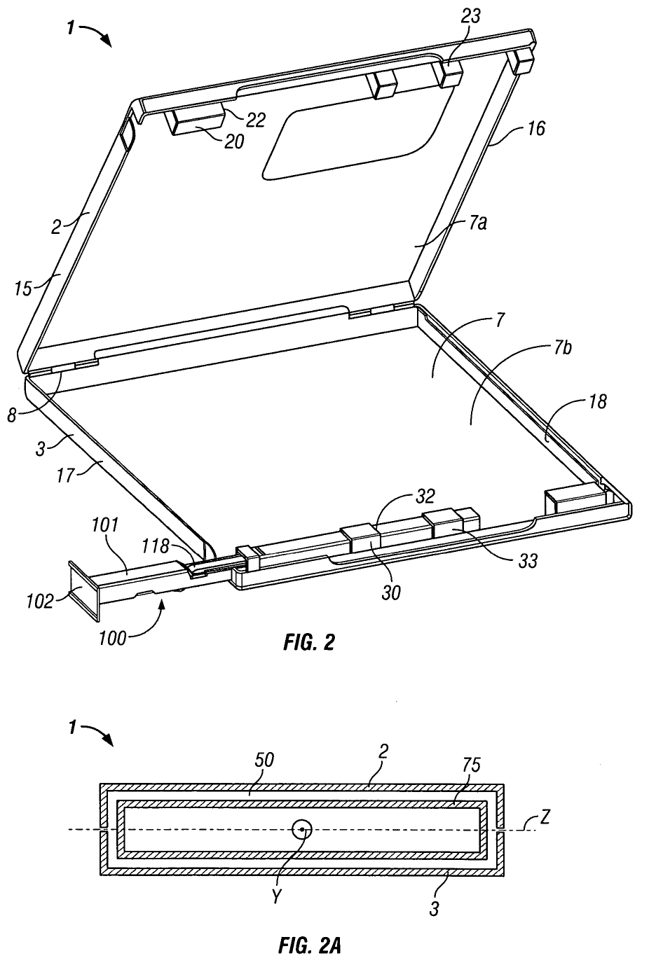

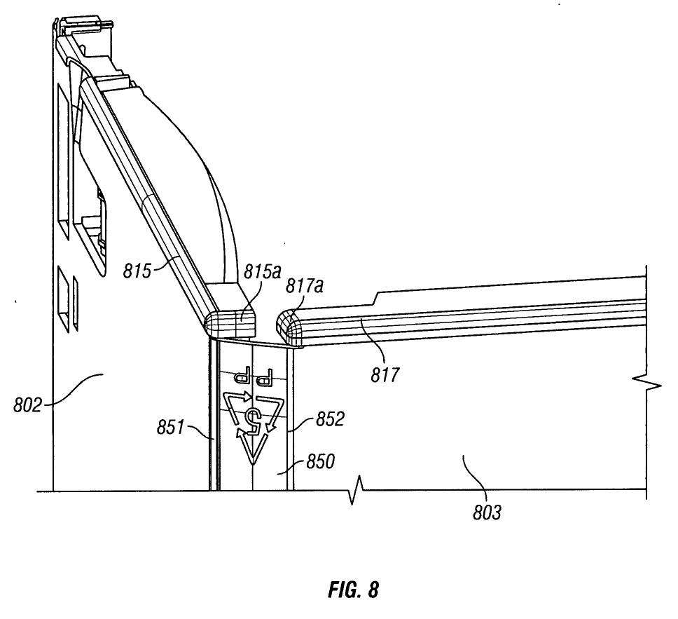

FIG. 2 shows containing element 1 in an open state. Containing element 1 may include compartment 7, which may be configured to receive an asset. Compartment 7 may be configured to receive an asset case. Compartment 7 may include walls 7a and 7b which may be planar. Side walls 15, 16, 17, 18, hinge 8, walls 7a and 7b and locking member 100 may define compartment 7 when locking member 100 is inserted in case 1. Enclosing member 2 and enclosing member 3 are shown coupled together by hinge 8. Hinge 8 may be an anti-theft hinge (not shown in FIG. 2) that has a pin hidden by enclosing member 2 and enclosing member 3. The hinge may run through hinge loops located on an inner surface of a containing element such as containing element 1 when the containing element is closed. Such a pin may be known as a “hidden pin.” Enclosing members 2 and 3 may be coupled together by a spine (like that shown in FIG. 8 in conjunction with a different embodiment of a containing element according to the principles of the invention).

Enclosing member 2 may include one or more lock receiving elements such as 20 and 23. Lock receiving element 20 may include beveled edge 22. In some embodiments, lock receiving elements 20 and 23 may be loops. Locking member 100 may be configured to engage beveled edge 22 via a catch mechanism such as catch mechanism 118, which may correspond to one of catch mechanisms 1118 and 1119 (shown in FIG. 11) to lock containing element 1 when containing element 1 is closed.

Enclosing member 3 may include one or more lock receiving elements such as 30 and 33. Lock receiving element 30 may include beveled edge 32. In some embodiments, lock receiving elements 30 and 33 may be loops. Locking member 100 may be configured to engage beveled edge 32 via a catch mechanism such as catch mechanism 1118 or 1119 (shown in FIG. 11) to lock containing element 1 when containing element 1 is closed.

FIG. 2A shows a cross-sectional view taken from line 2A-2A (shown in FIG. 1) of illustrative containing element 1. (For the sake of simplicity, container 75 is not shown in FIG. 1, in which container 75 may be visible through window 4.) Containing element 1 is closed around container 75. Container 75 may contain any asset that is to be secured. Gap 50 between enclosing members 2 and 3 and container 75 may be sufficiently small that the rotation of container 75, for example, about axis Y or axis Z is small enough to prevent damage to container 75 during shipping or handling. Gap 50 may be sufficiently small that any displacement of container 75 with containing element 1 is too small to damage container 75 during shipping or handling. For the purpose of illustrating the invention, enclosing members 2 and 3 will be defined as being “nearly flush” with container 75 when the foregoing rotation and displacement conditions are satisfied.

Gap 50 between enclosing members 2 and 3 and container 75 may be sufficiently small that there may be no rotation of container 75, for example, about axis Y or axis Z during shipping and handling. Gap 50 may be sufficiently small that there is no displacement of container 75 with containing element 1 during shipping and handling. For the purpose of illustrating the invention, enclosing members 2 and 3 will be defined as being “flush” with container 75 when the foregoing rotation and displacement conditions are satisfied.

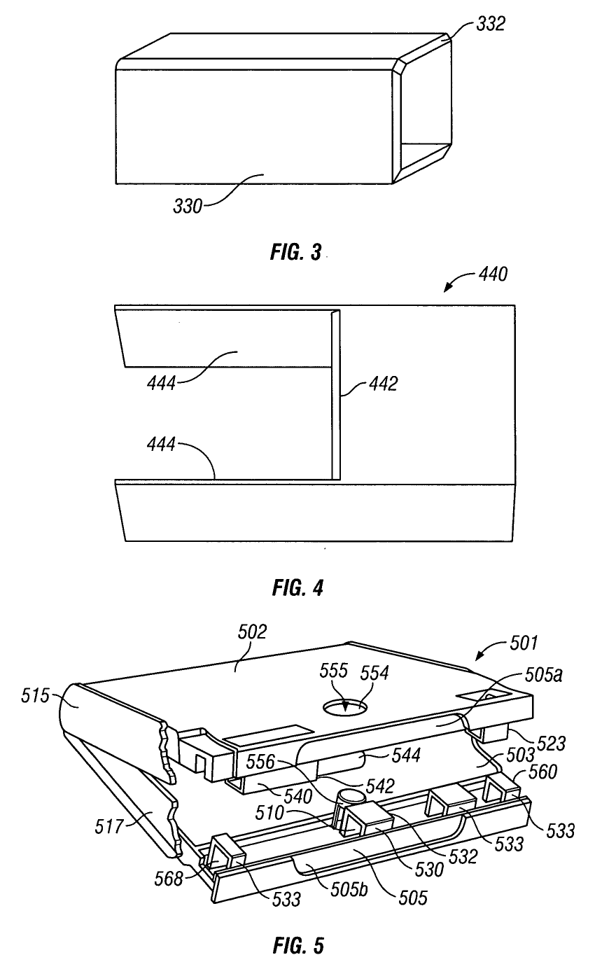

FIG. 3 shows a detailed view of lock receiving element 330, which is a loop, and beveled edge 332. Lock receiving element 330 may correspond to one or more of lock receiving elements 20 and 30 shown in FIG. 2.

FIG. 4 shows illustrative lock receiving element 440. Lock receiving element 440 may include beveled edge 442, which may be configured to engage a locking member such as locking member 100. Lock receiving element 440 may include protective sides 444 extending away from beveled edge 442. Protective sides 444 may improve tamper resistance of containing element 1 by preventing access to locking member 100 when locking member 100 is engaged with beveled edge 442 via a catch mechanism such 1118 or 1119 (shown in FIG. 11).

FIG. 5 shows illustrative containing element 501, which may contain one or more loosely placed assets. Containing element 501 may include enclosing member 502 and enclosing member 503. Enclosing member 502 may be flexibly coupled to enclosing member 503 and may be configured to be moved to a position adjacent enclosing member 503 to close containing element 501.

Containing element 501 may include finger slot 505 to facilitate opening containing element 501. Finger slot 505 may include one or more of the features of finger slot 5 (shown in FIG. 1).

Enclosing member 502 may include one or more lock receiving elements such as representative lock receiving element 540. Enclosing member 502 may include one or more lock receiving elements such as representative lock receiving element 523. Lock receiving element 540 may include beveled edge 542 and protective sides 544. Lock receiving element 540, beveled edge 542, and protective side 544 may include, respectively, one or more of the features described in connection with lock receiving element 440, beveled edge 442, and protection side 444 (all shown in FIG. 4).

Enclosing member 503 may include one or more lock receiving elements such as representative lock receiving element 530. Enclosing member 503 may include one or more lock receiving elements such as representative lock receiving element 533. Lock receiving element 530 may include beveled edge 532. Lock receiving element 530 and beveled edge 532 may include, respectively, one or more of the features described in connection with lock receiving elements 330 and beveled edge 332 (shown in FIG. 3).

Lock receiving element 540 may include beveled edge 542. Lock receiving elements 530 and 540 may be configured to engage a locking member such as locking member 100, while lock receiving elements 523 and 533 may be configured to receive a base of a locking member such as base 101 of locking member 100.

Enclosing member 502 may include wall 515. Enclosing member 503 may include wall 517. Wall 515 may be configured to overlap with wall 517 when containing element 501 is closed.

Enclosing member 502 may include hole 554. Enclosing member 503 may include hollow tube 556. Hole 554 may be configured to be aligned with hollow tube 556 when containing element 501 is closed to create passageway 555 through enclosing members 502 and 503. Passageway 555 may be used to hang containing element 501 from a peg or other suitable structure.

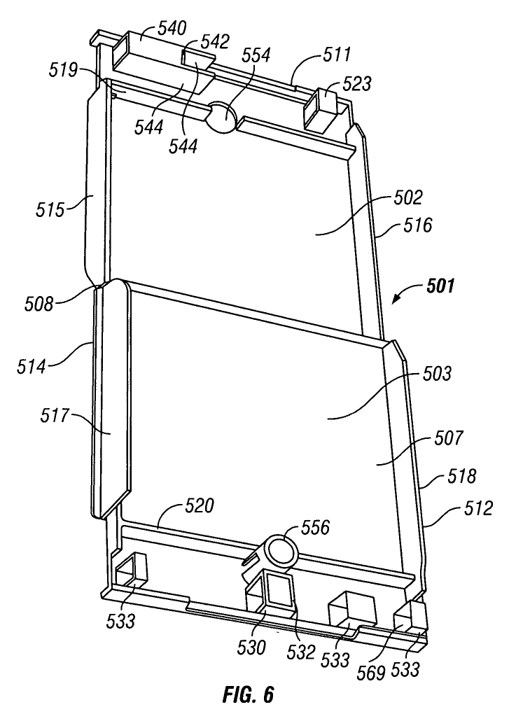

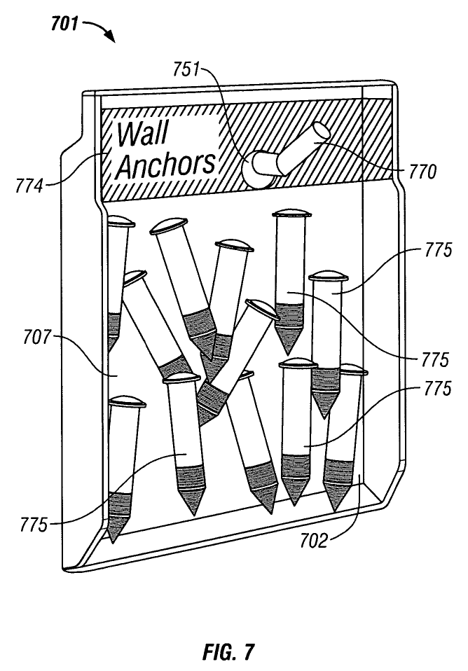

Lock receiving elements 523, 530, 533 and 540 may define locking channel 510 when containing element 501 is closed. Locking channel 510 may have one or more of the features of locking channel 10 (shown in FIG. 1). FIG. 6 shows that locking channel 510 may be sealed by wall member 560 (shown in FIG. 5) on side 512 of containing element 501. Channel opening 568 may be defined by the first loop 533 of enclosure member 503. In some embodiments, one or both of channel opening 568 and wall member 569 may be disposed on enclosure member 502. In some embodiments, one of channel opening 568 and wall member 569 may be positioned on enclosure member 502 and the other on enclosure member 503.

FIG. 6 shows containing element 501 in an open state. Enclosure member 502 may include side wall 516. Enclosure member 503 may include side wall 518. Side walls 515, 516, 517, 518, walls 519 and 520, hinge 508, and enclosing members 502 and 503 may define compartment 507. Walls 515, 516, 517, 518, 519 and 520 may be sufficiently contiguous when containing element 501 is closed to retain small detached assets. If side walls 515, 516, 517 and 518 overlap, only the inner walls are necessary to define compartment 507. Compartment 507 may detachedly contain one or more assets.

Enclosure member 502 may be coupled to enclosure member 503 by hinge 508, which may be a living hinge or a pinned hinge. Enclosure member 502 may be coupled to enclosure member 503 by a spine (such as that shown in FIG. 8 in connection with a different embodiment of the containing element). Hinge 508 may have one or more of the features of hinge 8 (shown in FIG. 1).

FIG. 7 shows illustrative containing element 701 mounted on display peg 770. Display peg 770 may fit through passageway 751. Containing element 701 may include clear enclosing member 702 to allow a shopper to view assets such as wall anchors 775 in compartment 707 of containing element 701.

Containing element 701 may be at least partially covered with graphic sleeve 774. Graphic sleeve 774 may be a print. Graphic sleeve 774 may be welded to containing element 701. Graphic sleeve 774 may be multicolored. Graphic sleeve 774 may be black and white. Graphic sleeve may include a durable or non-removable label for one or more of a caution statement, a warning and an advertising graphic. Graphic sleeve 774 may be placed inside containing element 701. Graphic sleeve 774 may be placed on containing element 701.

Containing element 701 may include a multicolor or black and white printed insert. The printed insert may provide a durable label for one or more of a caution statement, a warning and an advertising graphic. The insert may be placed inside containing element 701. The insert may be placed on containing element 701.

FIG. 8 shows illustrative living hinge 851 coupling enclosing member 802 to spine 850 and living hinge 852 coupling enclosing member 803 to spine 850. Side wall 815 may include overlapping feature 815a. Side wall 817 may include overlapping feature 817a. Overlapping feature 815a may be configured to fit over the end of living hinge 851. Overlapping feature 817a may be configured to fit over the end of living hinge 852. Other side walls (not shown) opposite side walls 815 and 817 may have overlapping features configured to fit over corresponding opposite ends of living hinges 851 and 852.

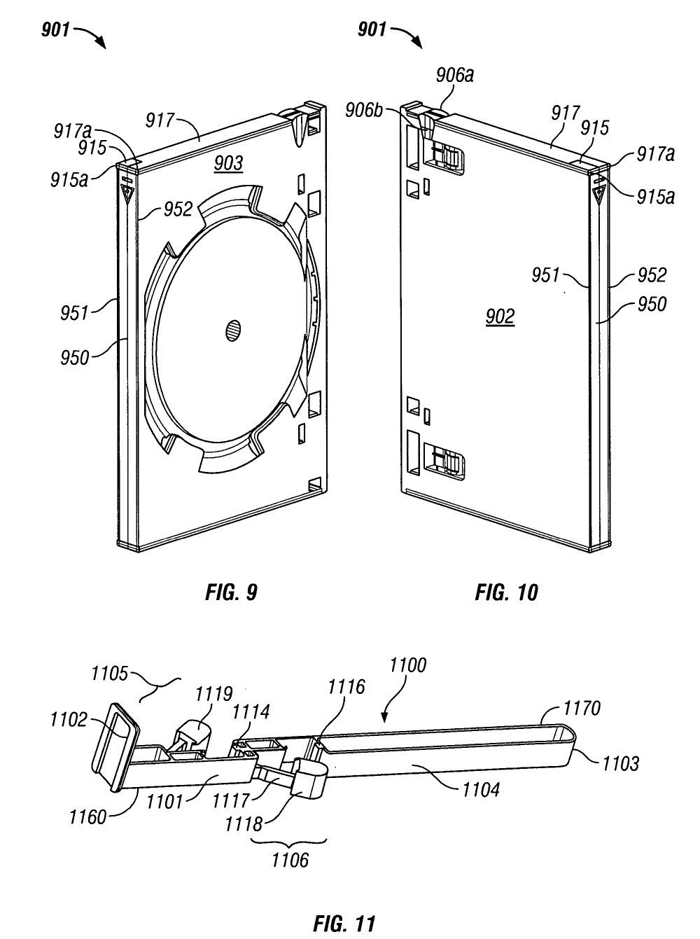

FIGS. 9 and 10 show illustrative containing element 901 in a closed state. FIGS. 9 and 10 show that when containing element 901 is closed, overlapping feature 915a may block access to the end of living hinge 951, and overlapping feature 917a may prevent access to living hinge 952. The overlapping features may prevent a shoplifter from inserting a cutting utensil at one end of one of living hinges 951 and 952 and slicing along the living hinge to cut open containing element 901.

FIGS. 11-25 show several illustrative locking members and associated apparatus in accordance with the principles of the invention.

FIG. 11 shows illustrative locking member 1100 which may be used in conjunction with a containing element in accordance with the principles of the invention. Locking member 1100 may include base 1101 and handle member 1102, located at proximal end 1160 of base 1101. Locking member 1100 may include blunt nose 1103 at distal end 1170 of locking member 1100. Locking member 1100 may include elongated portion 1104.

Locking member 1100 may include one or more catch assemblies such as 1105 and 1106. Catch assembly 1106 may include representative catch mechanism 1118. Catch assembly 1106 may include representative flexible stem 1117. Catch assembly 1106 may include representative stabilizer 1116. Flexible stem 1117 may be connected to base 1101. Catch mechanism 1118 may be connected to an end of flexible stem 1117. Catch mechanism 1119 may be connected to the end of another flexible stem.

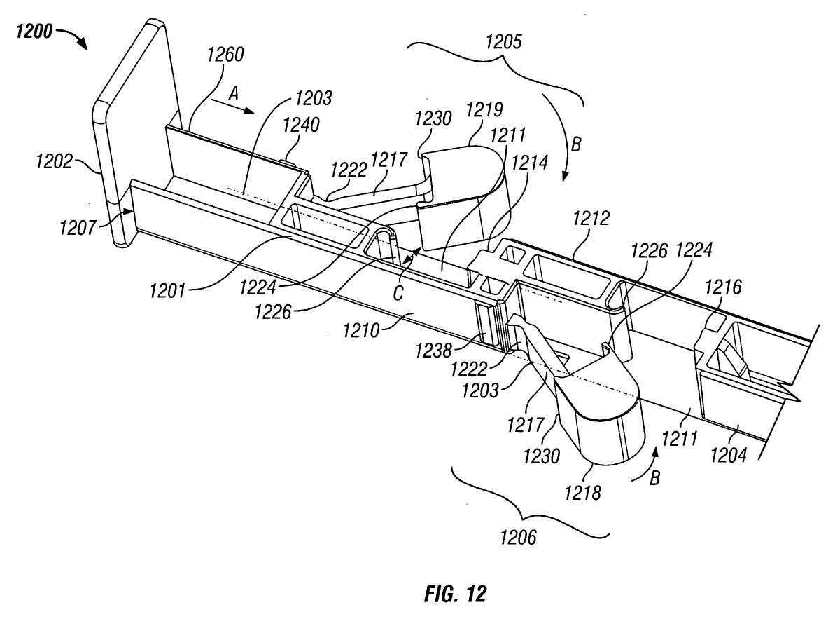

FIG. 12 shows a portion of illustrative locking member 1200. Catch assembly 1206 may include catch mechanism 1218, which may be connected to one of flexible stems 1217. Each of flexible stems 1217 may be connected to one of hinges 1222, each of which may connect one of stems 1217 to base 1201. Hinge 1222 may be a living hinge. Each hinge 1222 may allow catch mechanisms 1218 and 1219 to move in direction B from the positions shown in FIG. 12 into region 1211. Each hinge 1222 may also move in the direction opposite direction B.

Hinge 1222 may be configured, for example, by injection molding, to maintain catch mechanism 1218 in an equilibrium position which part or all of catch mechanism 1218 is disposed outside the portion of outer periphery 1203. Hinge 1222 may be biased to urge catch mechanism 1218 back to the equilibrium position when catch mechanism 1218 is displaced from the equilibrium position. For example, catch mechanisms 1218 and 1219 may have equilibrium positions in which catch mechanisms 1218 and 1219 are entirely outside outer periphery 1203.

Catch mechanism 1218 may include flange 1224. Base 1201 may include detent 1226 configured such that flange 1224 may engage detent 1226. When flange 1224 is engaged with detent 1226, and the equilibrium position of catch mechanism 1218 is outside outer periphery 1203, catch mechanism 1218 may be retained at least partially within region 1211. Flange 1224 and detent 1226 may be configured such that edge 1230 may extend beyond wall 1210 when flange 1224 and detent 1226 are engaged. When flange 1224 and detent 1226 are engaged, edge 1230 may engage a containing element. When edge 1230 is engaged with a containing element, locking member 1200 may not be withdrawn from the containing element (e.g. in a direction opposite A). For example, edge 1230 may engage a portion of a containing element such as beveled edge 532 (shown in FIG. 5).

If a force in a direction opposite A is applied to locking member 1200 when edge 1230 is engaged with the containing element, stem 1217 may be stretched in direction A and catch mechanism 1218 may be stretched or displaced in direction A (or another direction) relative to other portions of locking element 1200. One or more stabilizers 1216 and 1214 may be present in locking member 1200 to arrest motion of catch mechanism 1218. Stabilizer 1216 may prevent catch mechanism 1218 from being broken off of base 1201. If one or more of catch mechanisms 1218 and 1219 were broken off of base 1201, locking member 1200 could possibly be withdrawn from the containing element.

When edges 1230 are disengaged from the containing element, locking member 1200 may be withdrawn from the containing element, for example by pulling handle member 1202.

In some embodiments of the invention, one or more channel stops such as representative channel stops 1238 and 1240 on walls 1210 and 1212, respectively, may be included. Channel stops 1238 and 1240 may prevent the insertion of an instrument or article in the locking channel of the containing element alongside locking member 1200. An instrument thus inserted could possibly contact catch mechanism 1218 or 1219 and be used to urge catch mechanism 1218 or 1219 in direction B, thus disengaging edge 1230 from the containing element. Channel stops 1238 and 1240 may be ribs that extend from walls 1210 and 1212, respectively, as shown in FIG. 12. Any suitable number, placement or geometry of channel stops may be used. Any suitable material or size of channel stops may be used. A channel stop may be attached to locking member 1200 in any suitable manner in any suitable location.

Locking member 1200 may include handle member 1202. Handle member 1202 may be connected to proximal end 1260 of base 1201 by intermediate connection member 1207. Connection member 1207 may be designed such that when locking member 1200 is engaged in the containing element, if a force is applied to locking member 1200 in a direction opposite A, connection member 1207 may break before one of stem 1217 and catch mechanism 1218 breaks.

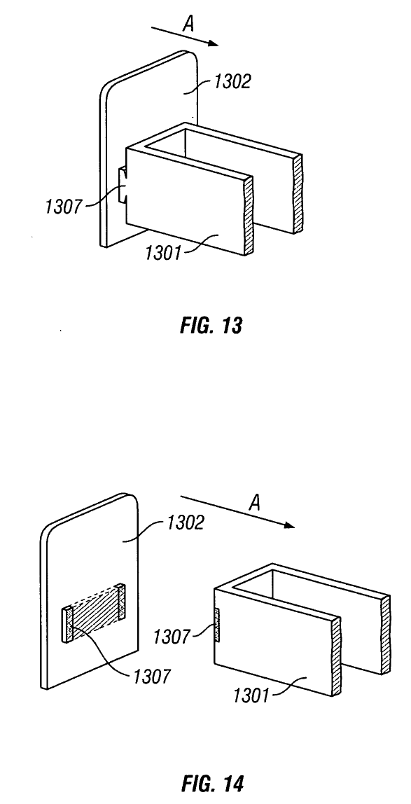

FIG. 13 shows illustrative connection member 1307 connected to handle member 1302 and to base 1301 (shown in part). Base 1301 may be the base of a locking member such as locking member 1201. If a force is applied to handle member 1302 along a direction opposite A when locking member 1300 is engaged with a containing element, and an edge such as edge 1230 is engaged, the stress on connection member 1307 may be higher than that on a hinge such as hinge 1222, because connection member 1307 may have a smaller area over which the force is distributed. Connection member 1307 may thus to stretch before hinge 1222. If the force is increased or sustained, connection member 1307 may break before hinge 1222. In some embodiments, a connection member may be made of material having mechanical properties that would cause the connection member to fail before the hinge.

FIG. 14 shows an example of handle member 1302 and base 1301 in a separated state. In the example, connection member 1307 has broken, and fragments of connection member 1307 remain attached to both handle member 1302 and base 1301. If a thief had attempted to pull handle member 1302 to remove a locking member (such as locking member 1200) from the containing element, he would have been prevented from opening the containing element to remove the asset or case enclosed therein.

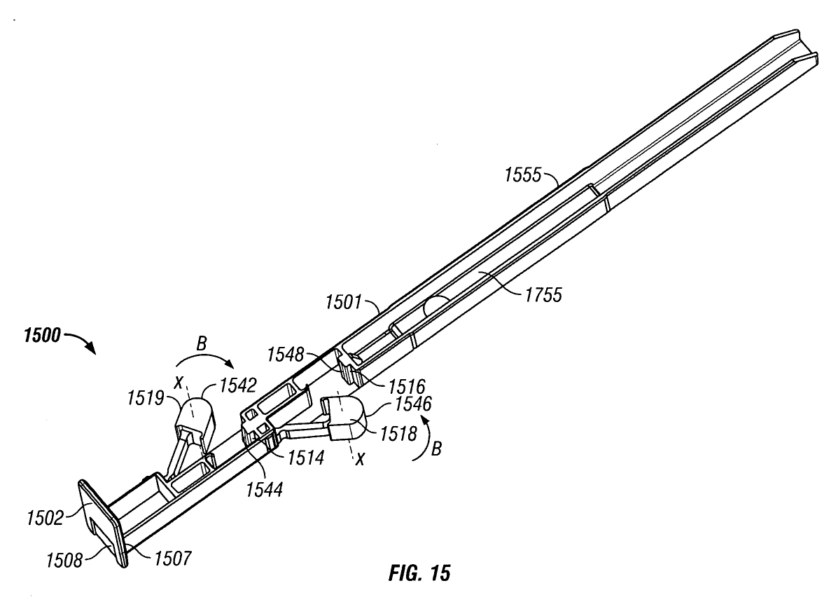

FIG. 15 shows illustrative handle member 1502 attached to illustrative locking member 1500. Recess 1508 in handle member 1502 may cause handle member 1502 to break before one of a hinge such as hinge 1222, a stem such as stem 1217, and a catch mechanism such as catch mechanism 1218 breaks. Recess 1508 may be configured to be located along the connection between handle member 1502 and base 1501. The connection defines connection member 1507 in this embodiment.

In some embodiments, locking member 1500 may include stabilizers such as representative stabilizers 1514 and 1516. Stabilizers 1514 and 1516 may include shaped surfaces 1544 and 1548, respectively. Surfaces 1544 and 1548 may be configured to conform to catch mechanism head portions 1542 and 1546, respectively. Each of stabilizers 1514 and 1516 may be of any suitable size, geometry, or material. A contoured stabilizer surface such as 1548 may reduce the likelihood of lock failure because the surface may retain catch mechanism 1518 in place when catch mechanism 1518 is subjected to stress.

Stabilizer 1516 may be configured to prevent catch mechanism 1518 from being displaced along direction B. Catch mechanisms 1519 and 1518 may include head portions 1542 and 1546, respectively, which may be any suitable shape, including without limitation a flat surface, a “V”-shape, or a curved surface. Representative catch mechanism head portion 1546 and corresponding stabilizer 1548 may be configured to prevent or reduce relative motion between head portion 1546 and stabilizer 1548 if head portion 1546 and stabilizer 1548 are in contact with each other.

Surfaces 1544 and 1548 are shown in FIG. 15 as concave surfaces that conform to head portions 1542 and 1546, which are convex. It will be appreciated, however, that a stabilizer surface according to the invention may be of any suitable shape.

Stabilizer 1514 and its components may include one or more features of stabilizer 1516, and head portion 1542 may include one or more features of head portion 1546.

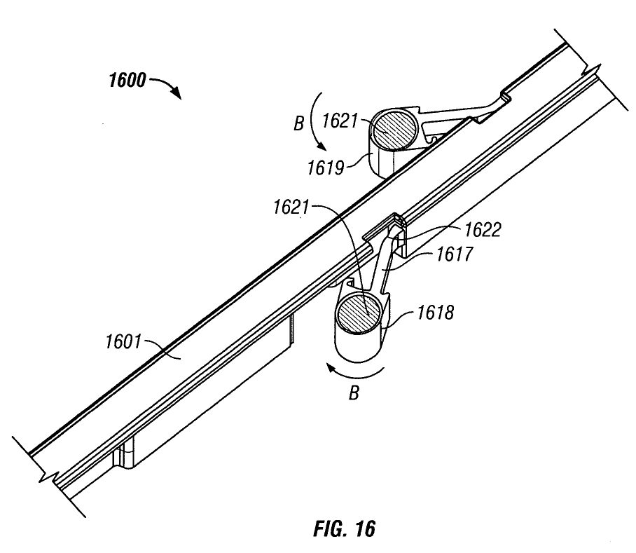

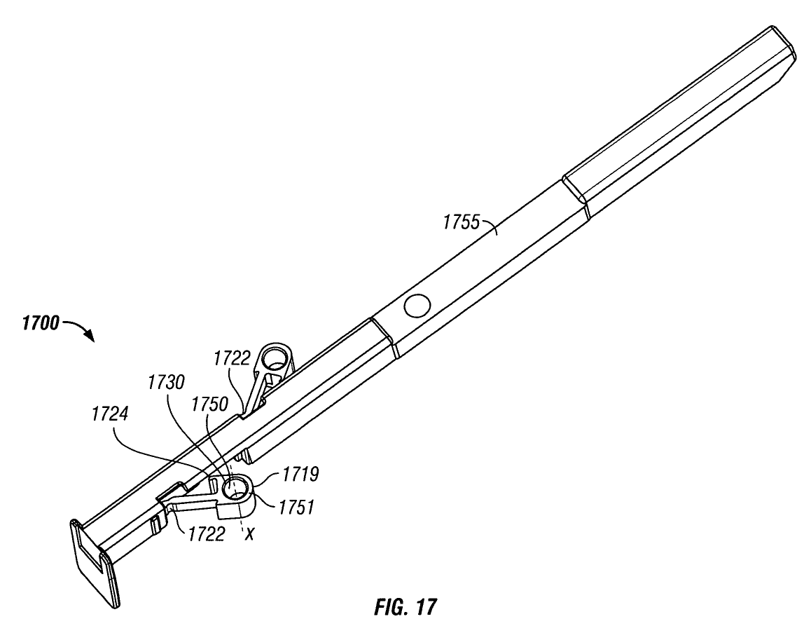

FIG. 16 shows a bottom perspective view of a portion of illustrative locking member 1600. Locking member 1600 may include a receptacle such as receptacle 1750 (shown in FIG. 17) in which magnetically reactive element 1621 may be present. A magnetic field may be applied to reactive element 1621 to disengage catch mechanism 1618 from a containing element by displacing catch mechanism 1618 in direction B. Magnetically reactive element 1621 may include any material that may be subject to a magnet force in the presence of a magnetic field, including without limitation steel, iron and any magnetic material. The reactive element may include a pin, plate, bead, sinter or any other suitable structure. Base 1601, catch mechanisms 1618 and 1619, stem 1617 and notch 1622 may correspond to base 1201, catch mechanisms 1218 and 1219, stem 1217 and notch 1222 (shown in FIG. 12). Locking member 1600 may include features such as, for example, an edge, a flange, a detent corresponding to features shown in FIG. 11.

FIG. 17 shows representative receptacle 1750 in which, for the sake of illustration, a magnetically reactive element such as 1621 is not shown. The size of the reactive element, its strength, or both, may be selected to require that any magnetic key used for disengaging lock 1700 from the container provide a magnetic field (present at or near the reactive element) that has a minimum strength. A reactive element of a size or strength smaller than that selected will thus require a stronger magnetic key to overcome bias (discussed in connection with FIG. 12) of hinges 1722. A magnetic key having less than the required strength may thus be “deactivated” by the selection of a reactive element size that is sufficiently small. The strength may be selected by any suitable method including without limitation selecting a material enriched in iron, an inherently magnetic material, or a material having enhanced magnetic properties, such as an electromagnet.

Receptacle 1750 may be of any suitable shape and may define axis X. Receptacle 1750 may be surrounded by receptacle wall 1751. Receptacle 1750 may have any suitable depth. Receptacle 1750 may have any suitable width perpendicular to X. If receptacle 1750 is cylindrical, as shown in FIG. 17, or approximately cylindrical, receptacle 1750 may have any suitable radius. Receptacle 1750 may have any suitable volume. Receptacle 1750 may be used to hold a small reactive element. Receptacle 1750 may be used to hold a large reactive element.

Receptacle wall 1751 may have any suitable thickness (for example, as measured from edge 1730 of receptacle 1750 to flange 1724). A thick receptacle wall may be less likely to deform or fail under stress than a thin receptacle wall. A thin receptacle wall may provide more space in the catch mechanism for a receptacle with a large radius.

Locking member 1700 may include tag support structure 1755, which may be a “cut-down” or recess of base 1701, as shown in FIGS. 15 (bottom view) and 17. Support structure 1755 may be configured to retain an article surveillance tag which may be any known suitable tag, including without limitation any of the tags, coils, or other devices shown or described in U.S. applications Ser. Nos. 09/858,457; 60/456,996 and 60/458,028. Locking member 1700 may include any suitable mounting features for affixing one or more of the aforementioned tags, coils, or devices.

Locking member 1700 may include features such as, for example, a catch mechanism, a stem, an edge, a flange, a detent corresponding to features shown in FIG. 11.

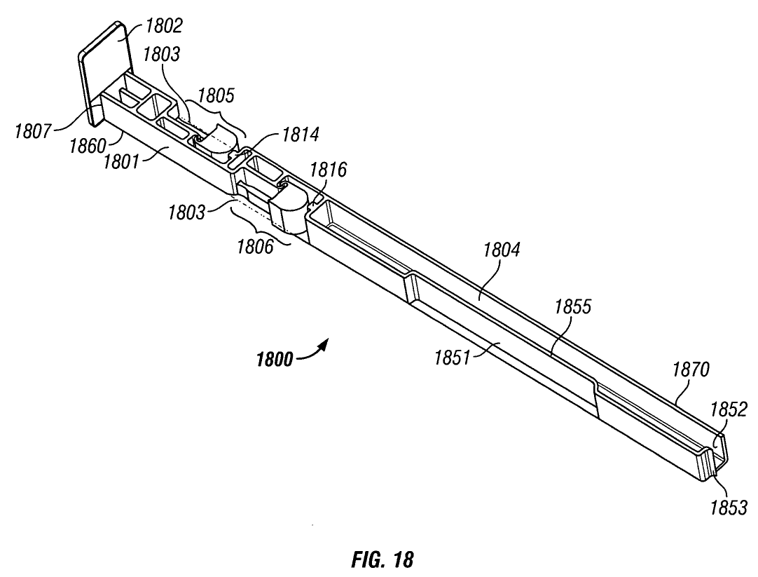

FIG. 18 shows illustrative tag support structure 1855 present on illustrative locking member 1800. Structure 1855 may include recessed portion 1851 in elongated portion 1804. A security tag may be affixed in recessed portion 1851 such that the security tag does not extend beyond outer periphery 1803 of elongated portion 1804. Structure 1855 may include channel 1852 defined in elongated portion 1804. A security tag may be affixed in any suitable portion of channel 1852. Channel 1852 may be partially closed at distal end 1870 by wall 1853. In some embodiments, wall 1853 may completely close distal end 1870.

In some embodiments, locking member 1800 may include one of recessed portion 1851 and channel 1852. In some embodiments, locking member 1800 may include both recessed portion 1851 and channel 1852. In some embodiments, locking member 1800 may include neither recessed portion 1851 nor channel 1852.

In some embodiments, one or both of recessed portion 1851 and channel 1852 may be configured to receive at least a portion of an asset situated in a containing element. In particular, if the asset is a DVD or a CD, a portion of the disc may extend into recessed portion 1851 or channel 1852 when the containing element is closed and locking member 1800 is inserted into the containing element.

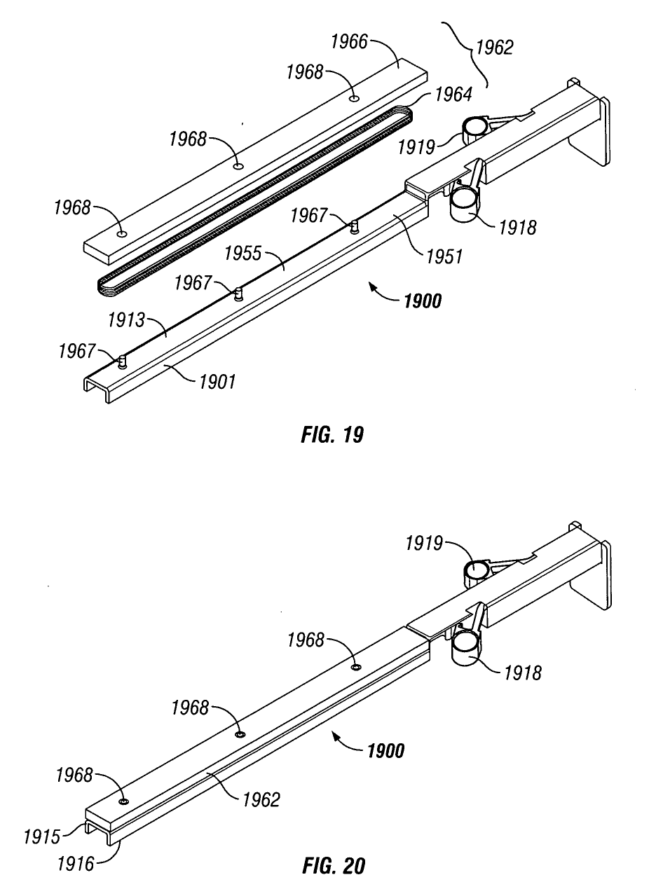

FIG. 19 shows illustrative locking member 1900, which may include illustrative tag support structure 1955. Support structure 1955 may include recessed portion 1951 along base 1901 of locking member 1900. Security tag 1962 may include coil 1964 and cover 1966. Support structure 1955 may include posts 1967 (on back surface 1913 of structure 1955) configured to engage holes 1968 in cover 1966. In some embodiments, security tag 1962 may be attached to lock 1900 using posts 1967. In some embodiments, security tag 1962 may be attached to lock 1900 using an adhesive (not shown in FIG. 19). Security tag 1962 may be attached to lock 1900 using one or more of a mechanical fastener, an adhesive, a mechanical snap-on mechanism, and any other suitable method.

Cover 1966 may be made of any suitable material and by any suitable method. In some embodiments, cover 1966 may include a ferrite bobbin (not shown), which may be a foredeck bobbin. The bobbin may be attached to cover 1966. Coil 1964 may be wound about the bobbin. The ferrite bobbin may increase the range of security tag 1962. The ferrite bobbin may increase the signal strength of tag 1962. In some embodiments, a ferrite member (not shown) may be attached to a locking member such as locking member 100. The coil may be fixed between cover 1966 and structure 1955.

FIG. 20 shows illustrative locking member 1900 when tag 1962 is attached to base 1901 of locking member 1900. In some embodiments, locking member 1900 and tag 1962 may fit, in combination, into a channel such as channel 510.

Coil 1964 may complete a resonant circuit. In some embodiments, the resonant circuit may have values of one or more of resistance, capacitance, and inductance that are chosen such that the reactance of the resonant circuit is a minimum at a specific resonant frequency. Coil 1964 may include a closed loop of a conducting element having at least one winding, which may be selected to have a certain value of resistance and inductance. The conducting element may be a metal wire, for example, copper, aluminum, or a metal alloy containing at least one of copper and aluminum. The conducting element may have two ends (not shown) which may be connected across a thin dielectric film (not shown) forming a capacitive element.

In some embodiments, the ends of the conducting element may be connected to a capacitive element which includes a pair of thin metal conducting films disposed on opposite sides of a dielectric. In some embodiments, the ends of the conducting element may be connected to an electric circuit having at least one capacitive element. In some embodiments, the values of the resonant circuit resistance, capacitance, and inductance are chosen such that the reactance of the resonant circuit may be minimum at a frequency in the radio frequency (“RF”) spectrum. This frequency will be referred to as the resonance frequency. In some embodiments, the resonance frequency may be about 8.2 MHz.

In some embodiments, coil 1964 may include a resonant circuit with a plurality of resonant frequencies. In some embodiments, coil 1964 may include a plurality of windings and capacitors. In some embodiments, coil 1964 may include a single winding connecting a plurality of capacitors in parallel.

In some embodiments, coil 1964 may be one or more of an RF coil security tag, a check-out tag and an inventory control tag. In some embodiments, coil 1964 may include a copper wire having one or more windings electrically connected to a Schottky barrier diode to form a resonant circuit which radiates a signal when subjected to high field strengths at selective frequencies. Although the data may be transferred to a reader, for example, by amplitude-modulating the carrier frequency, the actual modulation of the information, which is contained in logical bits of highs and lows, for example, 1's and 0's, may be accomplished using one or more of direct modulation of the amplitude, frequency shift keying and phase shift keying.

Frequency shift keying is a form of modulation using two different frequencies for data transfer. For example, a low bit is transmitted as an amplitude modified clock cycle with a period corresponding to a carrier frequency divided by an integer, and a high bit is transmitted as an amplitude modulated clock cycle corresponding to the carrier frequency divided by a different integer. In phase shift keying, only one frequency is used, and the shift between the highs and lows is accomplished by shifting the phase of the amplitude modulated frequency. For example, the phase may be changed by 180° at any low bit or at any data chain, from low to high or high to low.

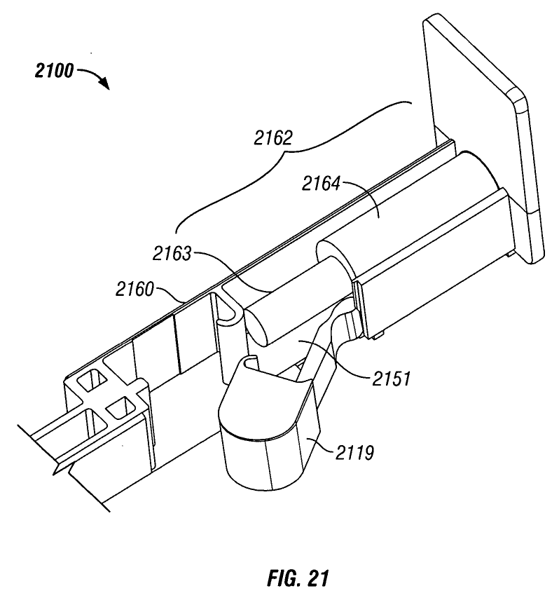

FIG. 21 shows illustrative security tag 2162, which may be an acousto-magnetic tag or coil. Tag 2162 may include core 2163, which may be a ferrite core. Tag 2162 may include coil 2164, which may be a ferrite coil. Tag 2162 may be sized and arranged to fit in recess 2151 in proximal end 2160 of locking member 2100 (partially shown). Recess 2151 may receive any of the known suitable tags. In some embodiments, tag 2162 may be a non-deactivatable acousto-magnetic tag. In some embodiments, the tag may be a device, such as a dual resonance (“DR”) tag, that may be available under the trademark SENSORMATIC from Sensormatic Electronics Corp. of Boca Raton, Fla. In some embodiments, tag 2162 may be an EAS tag.

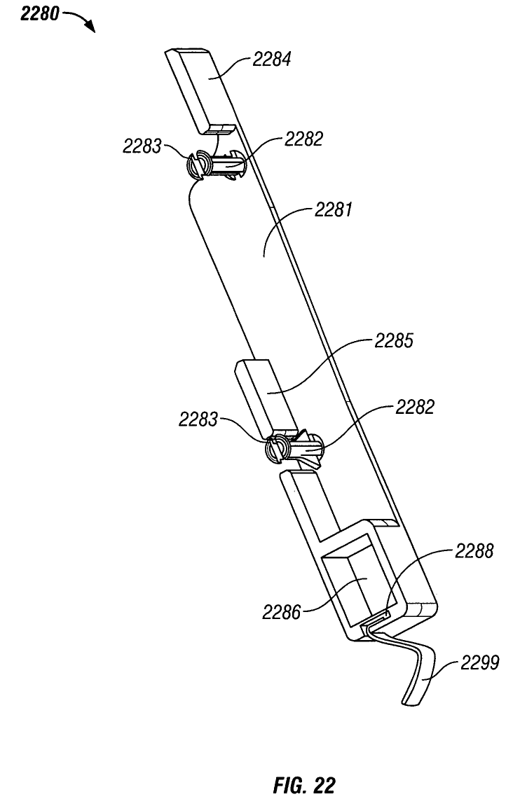

FIG. 22 shows illustrative actuator mechanism 2280, which may be used, according to the principles of the invention, in conjunction with a locking member to prevent a catch mechanism from being disengaged from a container. Actuator mechanism 2280 may include actuator base 2281, which may include at least one pin 2282. Pins 2282 may be molded to base 2281 or attached to base 2281 by any suitable method. Each pin 2282 may include a notched head 2283. Actuator base 2281 may include tab 2284 and tab 2285. Actuator base 2281 may include enclosure 2286, which may be configured to receive magnetically reactive material (not shown). Actuator base 2281 may include slot 2288, which may be present in the wall of enclosure 2286. Slot 2288 may be configured to receive spring 2299, which may be a compression spring.

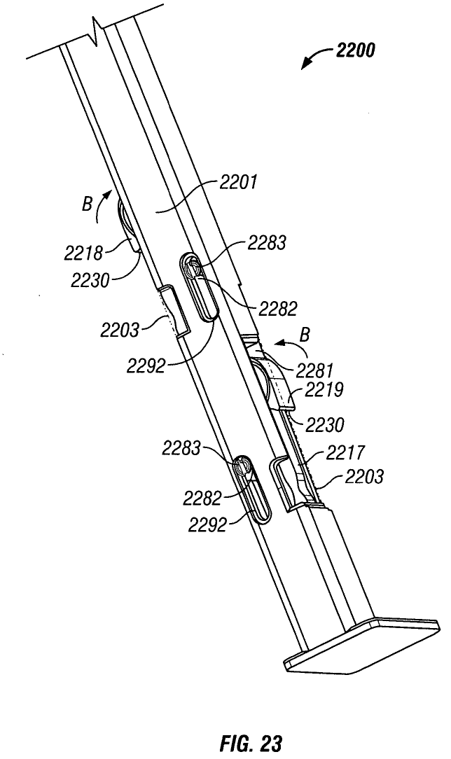

FIG. 23 shows a portion of illustrative locking member 2200 configured to operate in conjunction with actuator 2280. Locking member 2200 may include slots 2292 configured to receive pins 2282. Slots 2292 may be configured such that notched heads 2283 are too large to permit pins 2282 to be removed from slots 2292. Actuating member 2280 may be configured to slide along slots 2292.

Edges 2230 of catch mechanisms 2218 and 2219 may extend beyond the outer periphery 2203 of base 2201, and tabs 2284 and 2285 (shown in FIG. 22) may be located behind catch mechanisms 2218 and 2219, respectively. When tabs 2284 and 2285 are in this position, tabs 2284 and 2285 prevent catch mechanisms 2218 and 2219 from being pushed in direction B by occupying the space behind each catch mechanism.

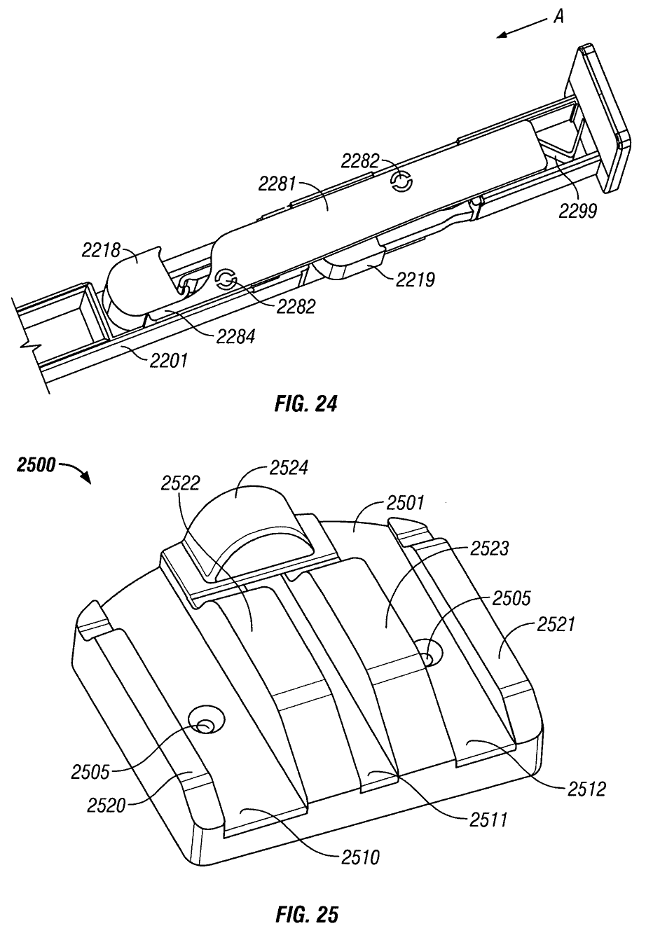

FIG. 24 shows tab 2284 inserted behind catch mechanism 2218. As actuating member 2280 slides along slots 2292 (shown in FIG. 23), tabs 2284 and 2285 (shown in FIG. 22) slide from positions behind stems 2217 to positions behind catch mechanisms 2218 and 2219, respectively. Actuator 2280 may be held by compression spring 2299 in such a position. When a magnetic field is applied to actuator 2280, actuator 2208 may move relative to base 2201 in the direction opposite direction A. When actuator 2280 moves in that direction, tabs 2284 and 2285 may release catch mechanisms 2218 and 2219 by allowing catch mechanisms 2218 and 2219 to move in respective directions B (shown in FIG. 23), thus allowing locking member 2200 to be removed from a containing element.

FIG. 25 shows illustrative decoupler 2500. Decoupler 2500 may include base 2501. Base 2501 may feature outer ridges 2520 and 2521, inner ridges 2522 and 2523, and rear ridge 2524. Outer ridges 2520 and 2521, and inner ridges 2522 and 2523 may define depressions 2510, 2511 and 2512. Decoupler 2500 may be configured to receive a containing element locked in a closed state by a locking member in a depression. Decoupler 2500 may provide a magnetic field configured to release the locking element from the containing element. Each depression may be configured to receive a selected type of containing element. Each depression may be configured to release a locking member with a reactive element (such as reactive element 1621, shown in FIG. 16) having a selected strength. Rear ridge 2524 may be configured to act on a reactive element placed in an enclosure such as enclosure 2286 of actuator 2280 (shown in FIG. 22). Base 2501 may be configured to include mounting holes 2505, which may be used to secure decoupler 2500 to a countertop or any other surface.

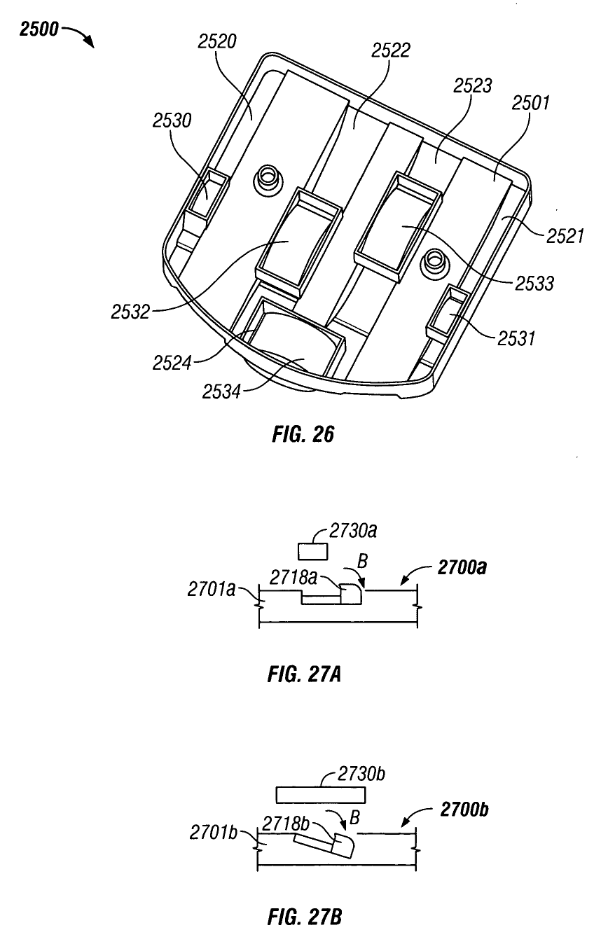

FIG. 26, showing a bottom view of decoupler 2500, shows outer magnets 2530 and 2531, which may correspond to outer ridges 2520 and 2521, respectively. Decoupler 2500 may include inner magnets 2532 and 2533, which may correspond to inner ridges 2522 and 2523, respectively. Each of magnets 2520, 2521, 2522 and 2523 may be located in any suitable position in a respective ridge. For example, in FIG. 26, magnet 2532 is closer to rear ridge 2524 than magnet 2533. Magnets 2520, 2521, 2522 and 2523 may be of any suitable size or material. Magnets 2520, 2521, 2522 and 2523 may be of any suitable strength. There are previously available decouplers being used outside of proper distribution facilities to open containing elements according to some of the principles of the invention. To prevent such decouplers from unlocking containing elements according to some of the principles of the invention, some locking members may be configured to have reactive elements which require larger magnets to overcome the bias in a hinge such as illustrative hinge 1122, thus rendering previously available decouplers obsolete. Magnets 2520, 2521, 2522 and 2523 may be selected to be stronger than those in previously available decouplers. In some embodiments, one or more of magnets 2520, 2521, 2522 and 2523 may be configured to release locking members with a specific configuration. In some of those embodiments, the magnets may be aligned with magnetically reactive material present in the locking members.

Decoupler 2500 may be configured to provide a magnetic field specific to a particular embodiment of a locking member according to the principles of the invention. Such locking members may vary in the number of catch mechanisms it may include, in the location of each catch mechanism, and in the size and material of a reactive element placed in each catch mechanism.

FIG. 27A schematically shows a portion of illustrative locking member 2700a, which may include catch mechanism 2718a. Magnet 2730a is in proximity of catch mechanism 2718a. Catch mechanism 2718a may be configured to have a small reactive element. Catch mechanism 2718a may be configured to have a weak reactive element. Catch mechanism 2718a may be configured to be off axis with magnet 2730a. The field provided by magnet 2730a may be too small to move catch mechanism 2718a in direction B, and therefore locking member 2700a remains in its previous position. In that position, catch mechanism 2718a would remain engaged with a containing element according to the principles of the invention.

FIG. 27B schematically shows a portion of illustrative locking member 2700b, which may include catch mechanism 2718b. Magnet 2730b is in proximity of catch mechanism 2718b. Catch mechanism 2718b may be configured to have a large enough reactive element. Catch mechanism 2718b may be configured to have a strong enough reactive element. Catch mechanism 2718 may be configured to be on axis with magnet 2730a. The field provided by magnet 2730b may be large enough to move catch mechanism 2718b in direction B, and therefore locking member 2700b may be displaced from its previous position. In the new position, catch mechanism 2718b may be disengaged from a containing element according to the principles of the invention.

A locking member may be configured to require two or more of a large enough reactive element, a strong enough reactive element, and a magnet on axis with the catch mechanism in order to move a catch mechanism to disengage the locking member from a containing element according to the principles of the invention.

Decoupler 2500 may include a security tag. The security tag may be used for tracking purposes. The security tag may impede a thief's ability to remove a decoupler such as decoupler 2500 from a distribution facility for use elsewhere.

It will be appreciated that features illustrated in connection with one containing element according to the invention may be present in some embodiments of other containing elements. It will be appreciated that features illustrated in connection with one locking member according to the invention may be present in some embodiments of other locking members.

It is seen that the systems and methods for securing an asset in a containing element have been provided. One skilled in the art will appreciate that the present invention can be practiced by other than the described embodiments, which are presented for purposes of illustration and not of limitation, and the present invention is limited only by the claims which follow. 1-25. (Canceled).

26. An asset locking system comprising:
a closable containing element comprising a first lock receiving element and a second lock receiving element, said first lock receiving element configured to be drawn together with said second lock receiving element to close said containing element, said first and second lock receiving elements enclosed within said containing element when said containing element is closed, said containing element comprising a compartment configured to detachedly contain at least one item; and
a locking member comprising a base configured to be at least partially present within said first lock receiving element and at least partially present within said second lock receiving element when said containing element is closed.

27. The asset locking system of claim 26 wherein said compartment is configured to contain a plurality of loose items.

28. The asset locking system of claim 26 wherein said compartment is configured to contain at least five loose items.

29. The asset locking system of claim 26 wherein said said containing element further comprises:
a first enclosing member configured to support said first lock receiving element; and
a second enclosing member configured to support said second lock receiving element, said second enclosing member coupled to said first enclosing member.

30. The asset locking system of claim 29 wherein said containing element comprises a passageway, said passageway passing through said first enclosing member and said second enclosing member.

31. The asset locking system of claim 26 wherein said containing element further comprises:
a first enclosing member configured to support said first lock receiving element, said first enclosing member comprising a first wall; and
a second enclosing member configured to support said second lock receiving element, said second enclosing member coupled to said first enclosing member and comprising a second wall;
wherein said first wall overlaps said second wall when said containing element is closed.

32. The asset locking system of claim 26 wherein said containing element comprises a graphic sleeve, wherein said sleeve is visible when said containing element is closed.

33. The asset locking system of claim 26 wherein said containing element comprises a graphic insert, wherein said insert is visible when said containing element is closed.

34. A locking member for use with an asset locking system, said system comprising a container including a locking channel, said locking member comprising:
a base including a security tag support structure; and
a security tag; wherein:
said base is configured to be inserted in said locking channel; and
said support structure supports said tag.

35. The locking member of claim 34 comprising a catch mechanism attached to said base and configured to be moved relative to said base by a magnetic field.

36. The locking member of claim 34 wherein said base comprises:
a proximal end;
a distal end configured to be inserted in said locking channel before said proximal end is inserted in said locking channel; and
said support structure is configured to be adjacent said proximal end.

37. The locking member of claim 34 wherein said base comprises:
a proximal end;
a distal end configured to be inserted in said locking channel before said proximal end is inserted in said locking channel; and
said support structure is configured to be adjacent said distal end.

38. The locking member of claim 34 wherein said support structure comprises a recess in said base.

39. The locking member of claim 34 wherein said support structure comprises a channel.

40. The locking member of claim 34 wherein said support structure comprises an enclosure.

41. The locking member of claim 34 wherein said security tag is a non-deactivatable security tag.

42. The locking member of claim 34 wherein said security tag comprises a coil.

43. The locking member of claim 34 wherein said security tag comprises a ferrite bobbin.

44. The locking member of claim 34 wherein said security tag is an acousto-magnetic tag.

45. The locking member of claim 34 wherein said security tag is configured to emit a radio-frequency signal.

46. The locking member of claim 34 wherein said security tag is an electronic article surveillance tag.

47. The locking member of claim 34 further comprising:
a catch mechanism configured to engage a lock receiving element of a containing element enclosure member; and
a stabilizer configured to stabilize said catch mechanism if said catch mechanism is displaced relative to said base when said locking member is moved away from said lock receiving element.

48. The locking member of claim 34 further comprising:
a catch mechanism configured to engage a lock receiving element of a containing element enclosure member; and
a channel stop configured to block access to said catch mechanism when said catch mechanism is engaged with said lock receiving element.

49. The locking member of claim 34 further comprising an actuator configured to prevent said catch mechanism from being disengaged from a lock receiving element attached to a containing element enclosure member when said catch mechanism is engaged with said lock receiving element.

50. The locking member of claim 49 wherein said actuator is configured to be actuated by a magnetic field.

51. The locking member of claim 50 wherein said magnetic field is provided by a magnetic decoupler.

52. The locking member of claim 35 comprising a handle member attached to said base and configured to break away from said base before said catch mechanism breaks away from said base when said locking member is pulled out of said containing element and said catch mechanism is engaged with a containing element.

53. A method for unlocking a containing element, said containing element configured to receive a locking member, said locking member comprising a magnetically releasable catch mechanism configured to engage said containing element, said method comprising:
providing a magnetically reactive element inside said containing element, said magnetically reactive element configured to remain stationary relative to said containing element when a first magnetic field is applied to said locking member; and
releasing said catch mechanism using a magnetic key generating a second magnetic field, said second magnetic field greater than said first magnetic field.

54. The method of claim 53 wherein said releasing comprises affixing said magnetic key to a fixture.

55. The method of claim 53 further comprising identifying a magnetic key configured to emit said first magnetic field.
